(19) United States
(12) Patent Application Publication
(10) Pub. No.: US 2016/0286901 A1
(43) Pub. Date: Oct. 6, 2016

(54) CORD CLAMPING DEVICE

(71) Applicant: FILTROS Y MALLAS INDUSTRIALES, S.A. DE C.V., Guadalupe (MX)

(72) Inventor: Gerardo Strobl Diener, Guadalupe, N.L. (MX)

(21) Appl. No.: 14/715,000

(22) Filed: May 18, 2015

(30) Foreign Application Priority Data
Mar. 30, 2015 (MX) MX-U-2015-000183

(51) Int. Cl. A43C 7/08; A43C 9/00; F16B 2/22

(52) U.S. Cl. CPC A43C 7/08; F16B 2/22; A43C 9/00

(57) ABSTRACT

The present invention refers to a cord clamping device used for closure or tying of cords through an internal clamping element for holding cords placed at the central passage of central clamping passing through the main body of the device, which has a cylindrical shape with rounded edges.

The conformation of cord clamping device allows it to be easily usable, engageable and attachable to various types of cords, or of even different textures to the conventional, keeping the cord solidly affixed to the clamping device, even under sudden movements or pressure, adjusting regardless of the surface characteristics or shape of cord, preventing slippage during the useful lifetime of the device.

### FIELD OF THE INVENTION

The present invention refers to a cord clamping device used for cords closure, tying or fastening, which is conceived primarily for use in backpacks, duffel bags, sweatpants, swimming items, and in general, for all types of items using a cord or similar object for closure.

### BACKGROUND OF THE INVENTION

Currently the closer state of the art relative to the cord clamping device of this invention is disclosed in various patent documents and utility model, such as U.S. Pat. No. 5,345,658, U.S. Pat. No. 5,440,788, U.S. Pat. No. 5,607,128, U.S. Pat. No. 5,970,586, U.S. Pat. No. 6,443,527, U.S. Pat. No. 6,871,375, U.S. Pat. No. 5,786,700, U.S. Pat. No. 7,891,056, US20030005557, WO2013068721 and CN1175392, which are far from having the arrangement and configuration of this invention, since they do not have integrated the essential elements for clamping cords as shown in this invention.

Although these documents address a cord clamping device, they do not show the conformation of the present invention. Furthermore, the advantages of the device submitted here, will be apparent to a person of ordinary knowledge in the area, of the following description of a preferred embodiment thereof.

### BRIEF DESCRIPTION OF THE FIGURES

To facilitate understanding and explanation of this invention, this descriptive memory is accompanied by figures in which has been shown by way of illustrative example and not igniting the scope of the invention, a case of preferred embodiment of the cord clamping device compliant to claims.

FIG. 1 shows a bottom view in perspective of the device.

FIG. 2 shows a top view in perspective of the device.

FIG. 3 shows a bottom view of the device.

FIG. 4 shows a lop view of the device.

FIG. 5 shows a mid-section view in perspective of the device.

FIG. 6 shows a mid-section view of the device.

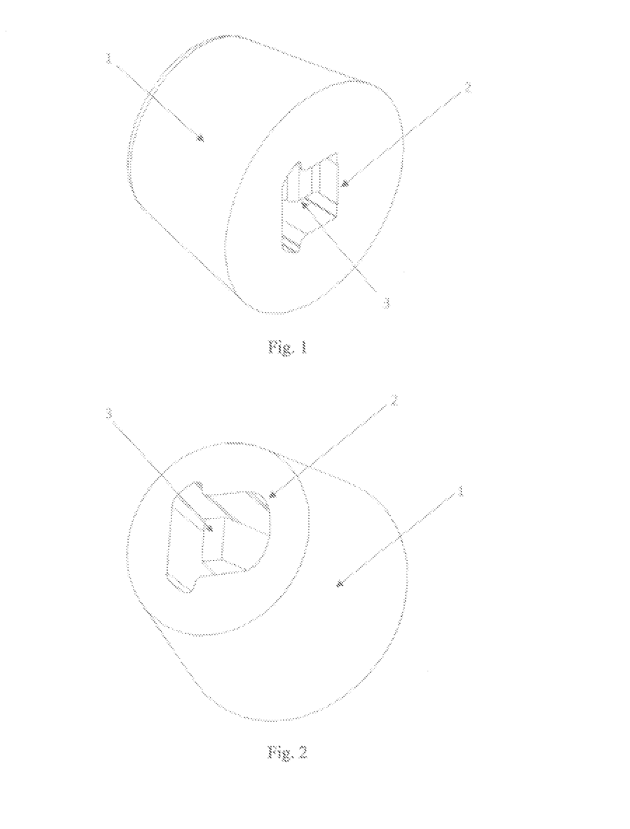

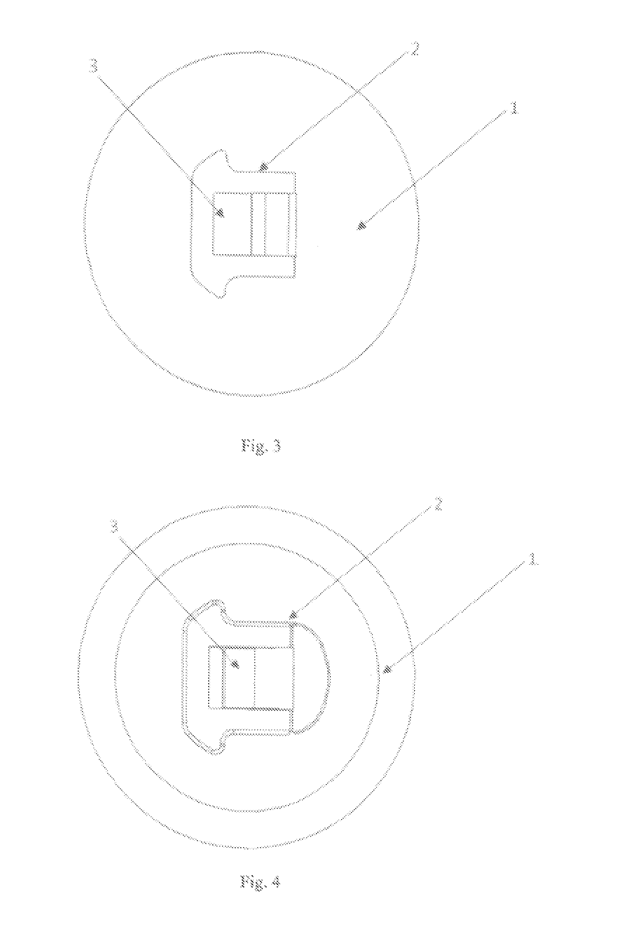

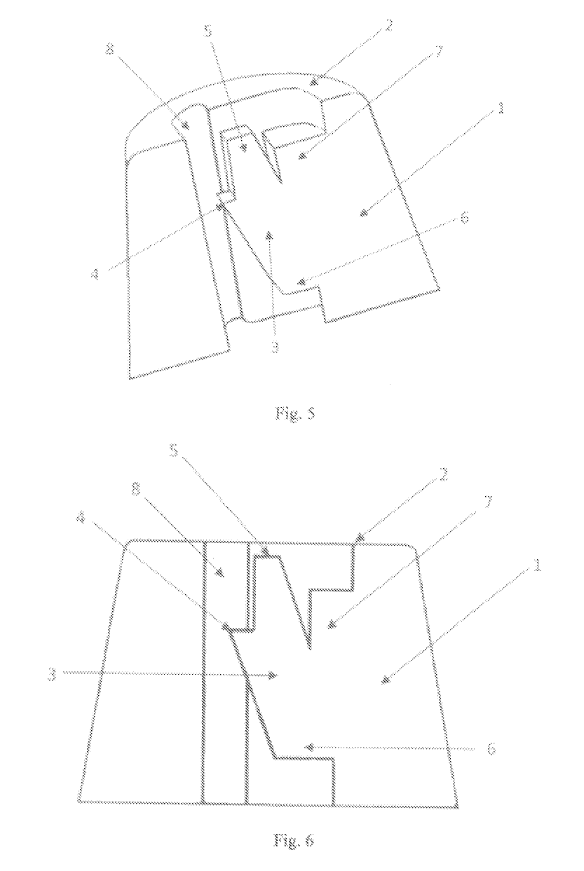

### BRIEF DESCRIPTION OF THE INVENTION

This invention makes reference to a cord clamping device used for closure or fastening of cords through an internal clamping element for cords clamping that by the configuration of its internal elements allows it to adapt and clamp efficiently cords.

### DETAILED DESCRIPTION OF THE INVENTION

The device of this invention is designed to replace cord tying means or methods with which it prevents the cord coming out of its position. In the device one or two ends of the cord are introduced and then slid through it, stopping at the desired position without returning in the opposite direction through the apex inside the device, which stops the cord sliding and holding it in the desired position.

The cord clamping device comprises a main body (1) with a cylindrical outer shape with a passage for central clamping (2) of cord formed through the two opposite ends of said body, and a clutching element (3) placed at the center of passage for central clamping (2) with a triangular apex (4) in the middle part, wherein said apex is positioned in the middle part of the main body. Particularly, the clamping element (3) is connected through a bar (5) to the wall of the passage for central clamping (2) through a projecting element (6) at the widest section of the main body (1) and a reinforcing element (7) in the thinner section of the main body (1). An important aspect is that the clamping element (3) must be placed at the center of the passage for central clamping (2) equidistant to the passage walls for central clamping (2) of the cord.

In a preferred embodiment of the cord clamping device, the passage for clamping is constituted by an inner hollow central portion preferably cylindrical with at least two cord passage channels (8) located laterally and longitudinally to the passage of central clamping, also, the main body (1) has rounded top and bottom edges to avoid hurting the user's skin or garment material in which the cord is being used.

Both in this device as in many others the material used is selected from one resisting deformation and wear due to washing, but specially for the device of this invention work was done with selected solid materials from metals or steel or aluminum alloys as well as plastics, preferably thermoplastic polymers.

The device of this invention retains the cord through the apex of the clamping element (3), which can get deformed in the displacement at the passage of cord and clamp it in a fixed location.

Unlike other cord clamping devices on the market, the device of this invention has demonstrated greater efficiency in different areas of handling and operation, even in commercial rigid cords, since it is easily usable, engageable and attachable to cords of different types, or, even different textures to the conventional, keeping the cord affixed solidly to the device, even under sudden movements or pressure, adjusting regardless of the surface characteristics or cord shape, preventing slippage during the months of life of the device. Also, by its simple and manageable nature allows there is a fair and secure clamp even when pressed.

It is to be understood that the description and figures submitted are as examples, not being restrictive regarding the invention and therefore is not limited to that illustrated but to the scope of the relevant claims.

Having described the invention as preceding, it is considered an innovation and thus is claimed as proprietary what is contained in the following:

1. A cord clamping device characterized because it comprises:
a) a main body (1) with a cylindrical outer form with
b) a passage for central clamping (2) of cord formed through the two opposite ends of said body
c) a clamping element (3) placed at the center of the passage of central clamping (2) with a triangular apex (4) in the middle part, wherein said apex is positioned in the middle part of the main body

2. A cord clamping device of claim 1 characterized in that the clamping element (3) is connected through a bar (5) to the passage wall for central clamping (2) through a projecting element (6) at the widest section of the main body (1) and with a reinforcing element (7) in the thinner section of the main body (1).

3. A cord clamping device of claim 1 characterized in that the clamping element (3) is placed at the center of the passage for central clamping (2) equidistant to the passage walls for central clamping (2) of the cord.

4. A cord clamping device of claim 1 characterized in that the clamping passage is constituted by an inner hollow central portion preferably cylindrical with at least two cord passage channels (8) located laterally and longitudinally to the passage for central clamping.

5. A cord clamping device of claim 1 characterized in that the upper and lower edges are rounded.

6. A cord clamping device of claim 1 characterized in that the body consists of a solid material selected preferably from steel, aluminum, thermoplastic polymer.
